(19) United States
(12) Patent Application Publication
(10) Pub. No.: US 2016/0076733 A1
(43) Pub. Date: Mar. 17, 2016

(54) LED SOFT LIGHT

(71) Applicant: MOLE-RICHARDSON CO., LTD, Hollywood, CA (US)

(72) Inventors: Brian Eustace, Sierra Madre, CA (US); Michael Davis, Running Springs, CA (US); Patrick Yi, Los Angeles, CA (US)

(73) Assignee: MOLE-RICHARDSON CO., LTD

(21) Appl. No.: 14/484,052

(22) Filed: Sep. 11, 2014

(51) Int. Cl. F21V 7/00; F21V 7/22; F21V 14/04; F21K 99/00

(52) U.S. Cl. CPC F21V 7/0033; F21K 9/30; F21V 7/0066; F21V 7/22; F21V 14/04; F21Y 2101/02

(57) ABSTRACT

An improved LED soft light is disclosed, which comprises a trough assembly; a plurality of LED light assemblies housed within the trough assembly, each of the LED light assemblies comprising one or more LEDs to emit light and an Primary reflector surrounding the one or more LEDs to direct the light emitted by the one or more LEDs; and a secondary reflector positioned proximate a rear portion of the trough assembly to reflect the light emitted by the plurality of LED light assemblies and direct the emitted light out of the front of the soft light.

### BACKGROUND OF THE INVENTION

The present invention relates generally to lighting devices, and more particularly to LED soft lights. Soft lights are generally used to create diffuse light that casts “soft” shadows or eliminates shadows entirely. Soft light results when light is bounced or diffused over a relatively large surface. Soft lights will generally utilize a combination of light sources to effectively create a single, large light source that casts diffuse light over a subject, creating softer shadow lines. However, it is often difficult to combine light sources into a single diffuse light source without creating “hotspots” that are generated by each of the individual light sources.

Soft lights generally utilize two primary means for creating soft light: shining light through a large frame of diffusion (often called “direct diffusion” lights); or bouncing light off a large white surface (often called “bounce lights”). Direction diffusion lights typically offer the conveniences of portability and lower costs, while bounce lights tend to offer a higher quality of light. As such, large studios or high-end productions tend to prefer bounce-type soft lights for the higher quality light produced by these lights.

Light emitting diodes (LEDs) are becoming more popular in lighting applications due to the fact that they are able to produce high intensity light with reduced power usage and heat output. However, creating a soft light using LEDs presents unique challenges. LEDs emit directed, high intensity light from a small surface area, leading to greater challenges in creating sufficient soft light output while also avoiding hotspots. While greater diffusion of the light will lead to softer light output with fewer hotspots, it also lowers the overall light output intensity.

It can readily be appreciated that there is a need for an LED soft light that emits soft light from a plurality of LED light sources with sufficient light output while remaining sufficiently soft. The present invention fulfills these needs and provides further related advantages.

### SUMMARY OF THE INVENTION

The present invention resides in an LED soft light in which a plurality of LED light assemblies having primary reflectors direct light towards a curved white secondary reflector. The light is reflected off of the curved, white secondary reflector and directed out of the soft light.

In a presently preferred embodiment of the invention, the soft light comprises a trough assembly; a plurality of LED light assemblies housed within the trough assembly, each of the LED light assemblies comprising an LED chip having one or more LEDs to emit light and a primary reflector surrounding the one or more LEDs to direct the light emitted by the one or more LEDs, each primary reflector having a reflector angle and a reflector height; and a secondary reflector having a radius of curvature and a curved, white reflection surface, the secondary reflector positioned proximate a rear portion of the trough assembly to reflect the light emitted by the plurality of LED light assemblies, wherein each primary reflector directs the light emitted by the one or more LEDs surrounded by the primary reflector towards the secondary reflector, and the light directed towards the secondary reflector by each of the primary reflectors is reflected by the white reflection surface of the secondary reflector and directed out of a front region of the soft light.

In the presently preferred embodiment, the reflector angle of each primary reflector may be between approximately 45 and 65 degrees, inclusive, and the reflector height may be between approximately 1 inch and 3 inches, inclusive. In a more particular aspect of this embodiment, the reflector angle may be approximately 55 degrees, and the reflector height may be approximately 2 inches. The reflector may comprise mirror-finish aluminum sheet material.

The secondary reflector of the presently preferred embodiment may have a radius of curvature between approximately 12 inches and 18 inches, inclusive. In a related aspect of this embodiment, the soft light may further comprise a curvature adjustment mechanism to adjust the radius of curvature of the secondary reflector. In a further aspect, the curvature adjustment mechanism may adjust the radius of curvature between approximately 12.25 inches and approximately 17.25 inches, inclusive. The secondary reflector may comprise low gloss white aluminum.

Each LED chip may be a 150 Watt (“W”) LED chip. The distance from each LED chip to the secondary reflector, measured perpendicular to the LED chip, may be between approximately 4 and 6 inches, inclusive. In a further aspect, the distance from each LED chip to the secondary reflector may be between approximately 4.95 and 5.00 inches, inclusive.

Each of the plurality of LED light assemblies may be positioned such that the light emitted by the plurality of LED light assemblies is directed towards the secondary reflector at a predetermined angle, the predetermined angle being defined relative to the normal of the tangent line to the secondary reflector at the point of intersection of the emitted light and the secondary reflector. The predetermined angle may be calculated so as to direct the emitted light off the secondary reflector and out of a front region of the soft light. The predetermined angle may be between 30 and 45 degrees, or, more particularly, approximately 37 degrees.

These and other features and advantages of the invention should become more readily apparent from the detailed description of the preferred embodiments set forth below taken in conjunction with the accompanying drawings, which illustrate, by way of example, the principles of the invention.

### BRIEF DESCRIPTION OF THE DRAWINGS

Embodiments of the present disclosure will now be described, by way of example only, with reference to the following drawings.

FIG. 1 provides a perspective view of an LED soft light having four LED assemblies, in accordance with an embodiment of the present invention.

FIG. 2 provides a perspective view of an LED soft light having two LED assemblies, in accordance with another embodiment of the present invention.

FIG. 3A provides a front plan view of the four LED assemblies of the soft light of FIG. 1.

FIG. 3B provides a perspective view of the four LED assemblies of the soft light of FIG. 1.

FIG. 4 provides an internal perspective view of the LED soft light of FIG. 1.

FIG. 5 provides an internal right plan view of the LED soft light of FIG. 1.

FIG. 6 provides a rear perspective view of the LED soft light of FIG. 1.

### DESCRIPTION OF THE INVENTION

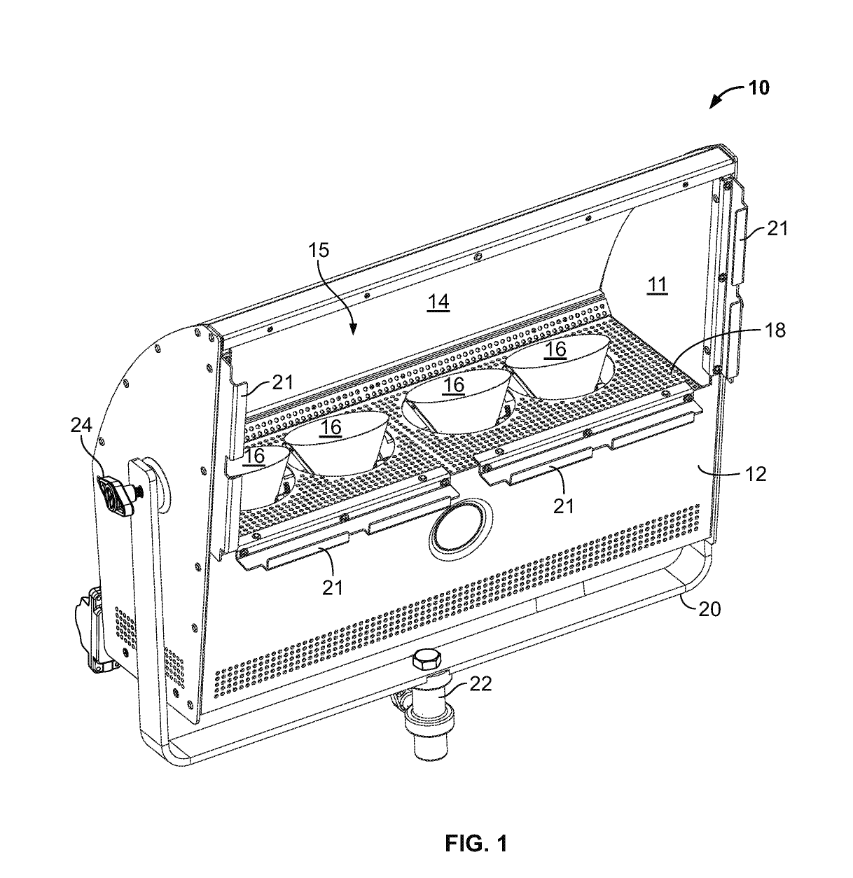

Referring now to the drawings, the present invention resides in a LED soft light which emits diffuse, soft light by reflecting the light output from a plurality of LED light sources off of a large, white reflector. FIG. 1 provides a perspective view of an LED soft light 10, in accordance with an exemplary embodiment of the present invention. The LED soft light 10 includes a trough assembly 12, a secondary reflector 14 having a white reflection surface, and four LED assemblies 16 housed within the trough assembly and directed towards the secondary reflector 14. On either side of the four LED assemblies 16 are side panels 11, which may be made of the same material as the secondary reflector 14 or some other reflective material to assist in reflecting the light emitted by the LED assemblies 16. The front region of the trough assembly 12 has an opening 15 through which the bounced light exits the soft light 10. While the opening 15 is shown in the figures as an open space, it should be understood that the opening 15 may include transparent or semi-transparent material through which the bounced light may exit. The opening 15 is surrounded by guide rails 21 that may receive filters such as a diffusion filter, color filter, or egg crate that is positioned over the opening 15 to create different effects on the output light.

A safety screen 18 surrounds the four LED assemblies 16 to restrict access to the electronics within the trough assembly 12. The safety screen 18 is also perforated so as to allow ventilation of heated air inside the trough assembly 12 that is generated by the LED assemblies and other electronics. The trough assembly 12 is rotatably connected to a yoke 20. The yoke 20 includes a 5/8 receiver 22 to mount the yoke on a lighting stand or otherwise secure the LED soft light 10 to a mount so that it can be positioned to provide light in a particular direction. The yoke 20 is rotatable about the trough assembly 12, but may be secured in a particular position to lock the LED soft light 10 in a desired position. In the embodiment shown, the yoke 20 may be locked in place by rotating and tightening a clamp knob 24. The clamp knob 24 may be loosened to allow the yoke 20 to rotate about the trough assembly 12.

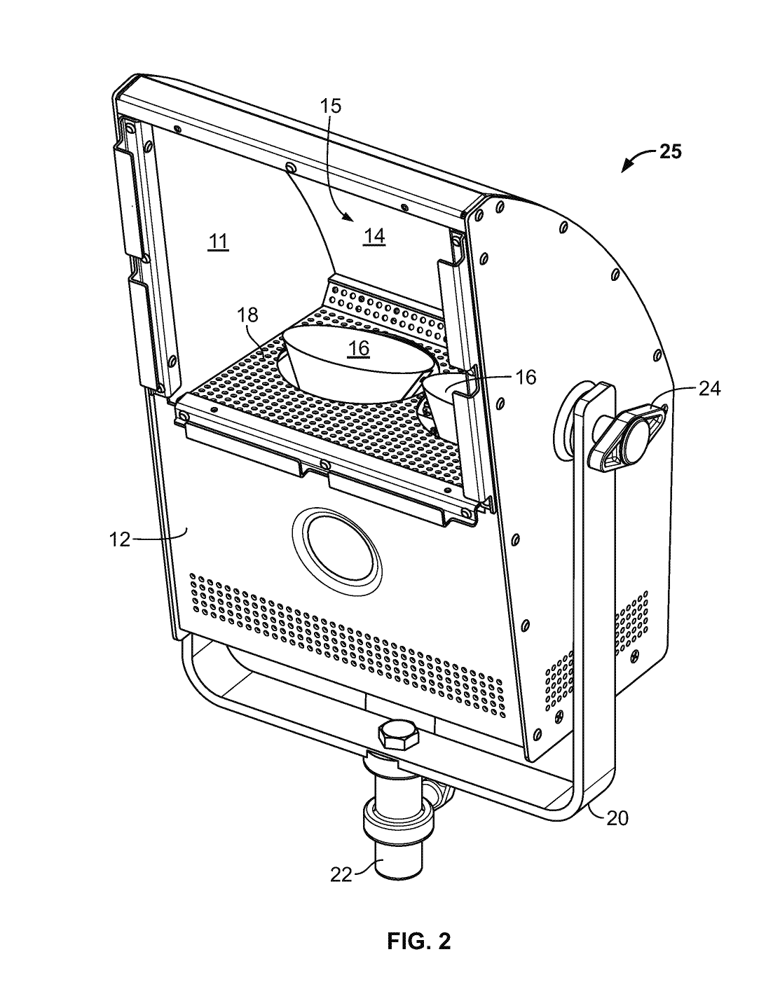

It should be understood that while the present disclosure will discuss the LED soft light 10 embodiment shown in FIG. 1 having four LED assemblies 16, the disclosed invention is not limited to this number of LED assemblies and may be applied to any sized LED soft light having any number of LED assemblies. For example, FIG. 2 provides another embodiment of an LED soft light 25 which has two LED assemblies 16.

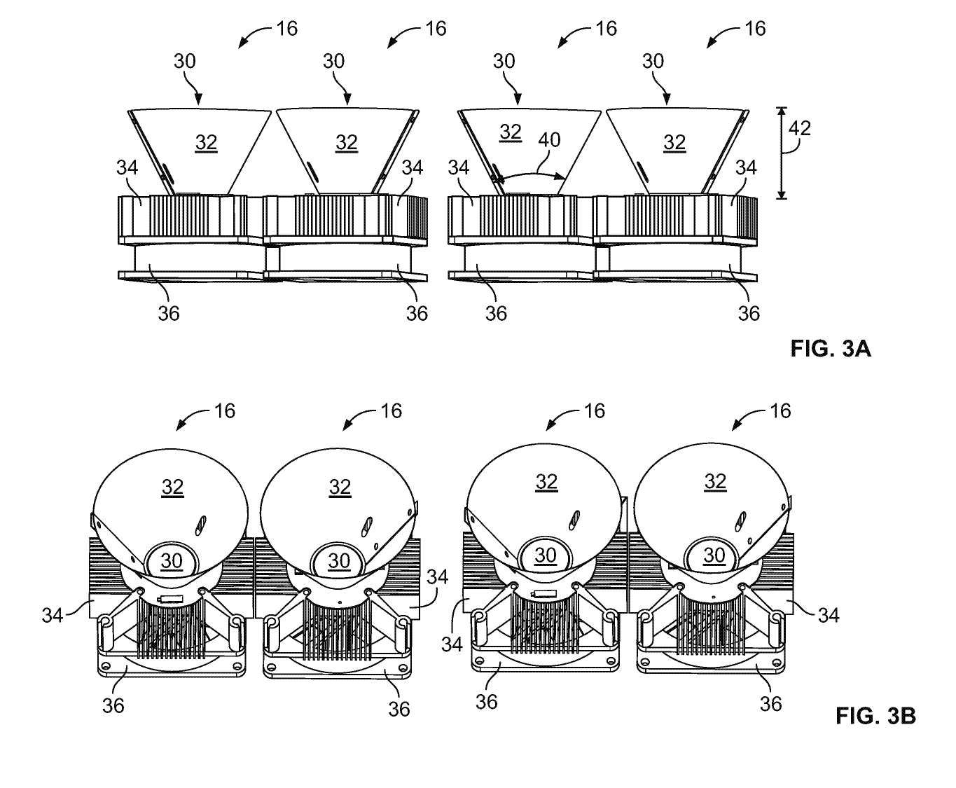

FIGS. 3A and 3B provide close-up views of the four LED assemblies 16. Each LED assembly comprises an LED chip 30 that includes one or more LEDs for emitting light and a primary reflector 32. The LED chip 30 may be any appropriate LED chip. In a preferred embodiment, the LED chip 30 is a 26 mm, 150 W LED chip, such as the 150 Watt Mole-Richard Quantum Dot LED. The primary reflector 32 surrounds the one or more LEDs of each LED chip 30 and at least partially directs the light emitted by the LED chip 30 towards the secondary reflector 14. By partially directing the light emitted by each LED chip 30, the primary reflectors 32 increase the amount of light directed towards and reflected by the secondary reflector 14 (discussed in greater detail below), thereby increasing the amount of light output by the soft light 10.

The primary reflector 32 can affect the light output of the soft light 10 and may be varied depending on the desired light output characteristics. For example, the shape of the primary reflector 32 will affect its effectiveness in reflecting the light from each LED chip. In the preferred embodiment shown in FIGS. 3A and 3B, each primary reflector 32 is frusto-conical in shape and has a conical angle. The conical angle of the primary reflector 32 is labeled as angle 40. A frusto-conical shape has been found to approximate or meet the performance of a parabolic reflector, while being generally easier and more cost-effective to manufacture. Alternatively, the primary reflectors may be parabolic, of course, or another appropriate shape.

Altering the angle 40 created by the primary reflector 32 will generally alter the intensity and directedness of the light emitted by the LED chip 30. Narrowing the angle 40 will generally result in a more directed, narrower beam of light being directed towards the secondary reflector 14, while widening the angle 40 will typically result in a wider beam with less direction. Altering the height 42 of the primary reflector 32 will also affect light output characteristics by varying how much light is captured and directed by the primary reflector 32. Using a primary reflector 32 with a shorter height will generally result in less light being reflected and directed by the primary reflector 32, as compared to a taller primary reflector. The exact angle and height of the primary reflector will depend on the size and light output characteristics of the LED chip 30, the size of the soft light 10, and the desired overall light output characteristics. In a presently preferred embodiment, using 26 mm, 150 W LED chips 30, such as the 150 Watt Mole-Richardson Quantum Dot LED, the reflector angle 40 may range from approximately 45 to 65 degrees, with a further preferred measure of approximately 55 degrees, and the height of the primary reflector 32 may range from approximately 1 to 3 inches, or more preferably from approximately 1.5 to 2.5 inches, with a further preferred height of approximately 2 inches.

The material of the primary reflector may also be varied to affect the light output characteristics of the soft light 10. In order to maximize light output, it may be preferable to use a highly reflective material. An example of a highly reflective material that may be used to form the primary reflector 32 is 0.020-inch thick mirror finish aluminum sheet material. However, other lighting effects may be desired which require less light output, and other materials may be used depending on the desired effect.

Each LED assembly 16 shown in FIGS. 3A and 3B further comprises a heatsink 34 and a fan 36 to remove heat from the LED chip 30. While the figures show a fin-type heatsink with a fan 34 to move heated air away from the heatsink 36, it should be understood that any appropriate cooling mechanism and/or heatsink may be used.

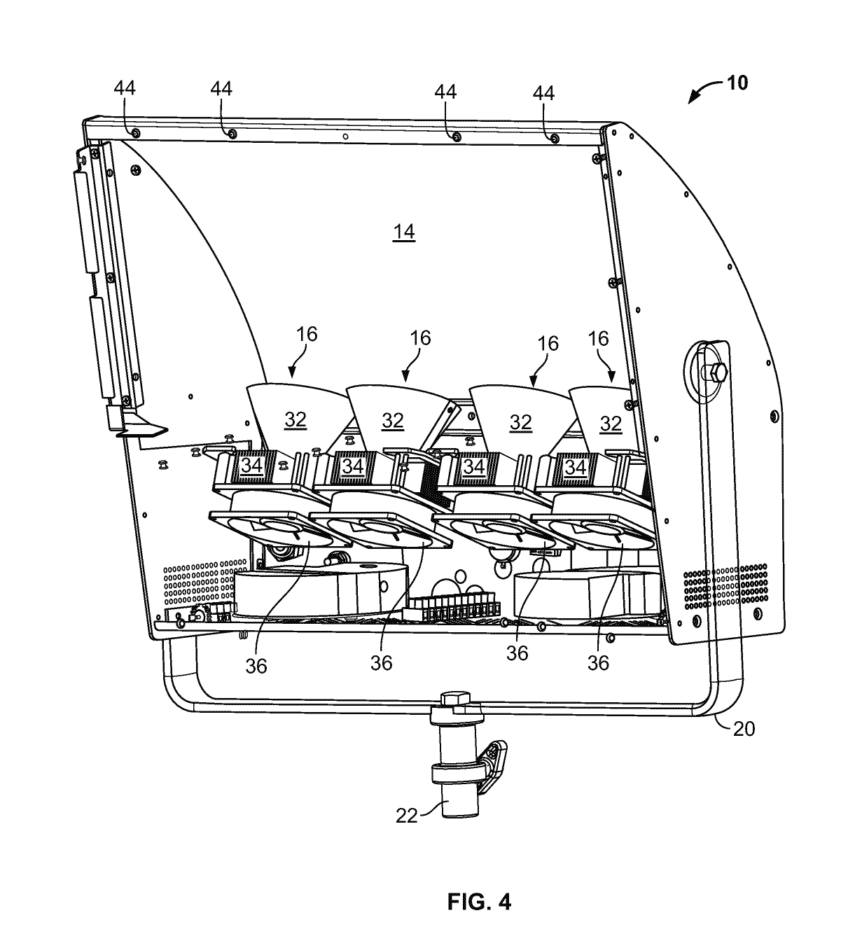

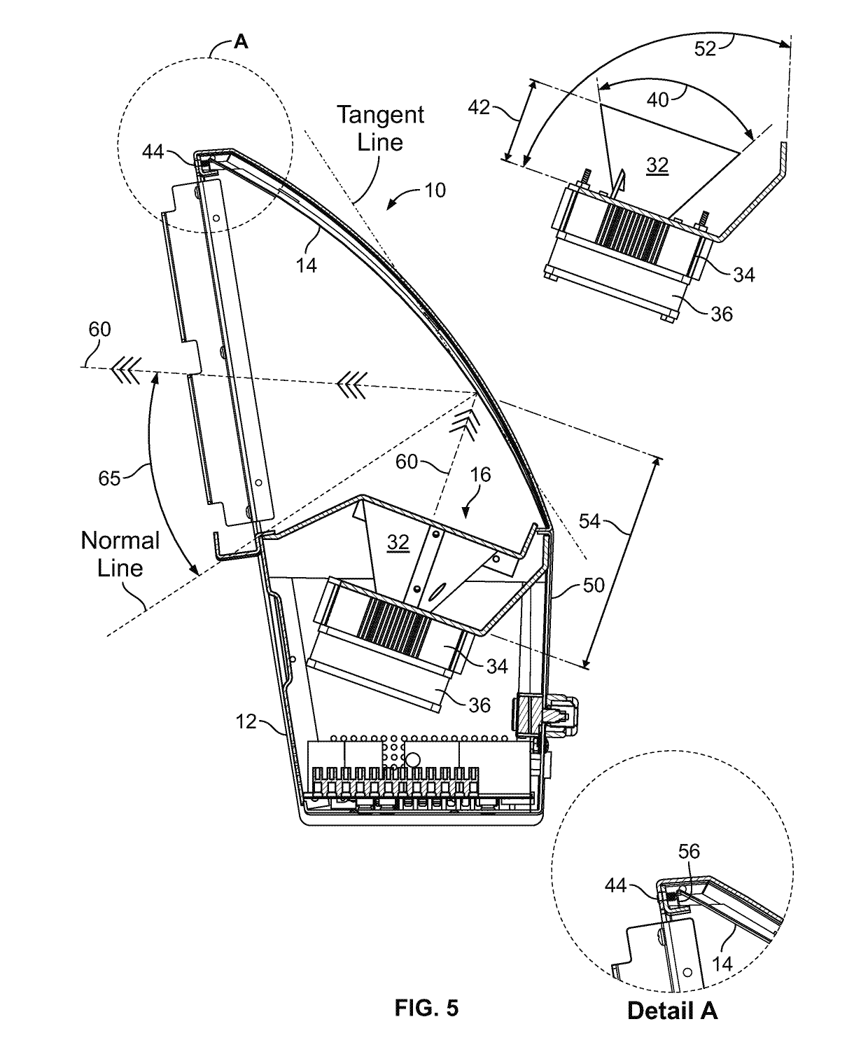

FIGS. 4 and 5 provide more detailed internal views of the soft light 10 to depict how light is directed from the LED assemblies 16 to the secondary reflector 14 and reflected out of the soft light 10. In FIG. 4, it can be seen that each of the LED assemblies 16 is mounted within the trough assembly 12 and directed at an upward angle towards the secondary reflector 14.

FIG. 5 provides a right plan view of the soft light 10. The LED assembly 16 is directed upwards towards the secondary reflector 14. The secondary reflector 14 has a white reflection surface off of which the light from the LED assemblies 16 is reflected. The secondary reflector 14 may also have a pre-determined radius of curvature. A beam of light 60 is emitted from the LED assembly 30 towards the secondary reflector 14, reflected off the white reflection surface of the secondary reflector, and then exits the soft light 10. Reflection of the light off of the white reflection surface of the secondary reflector results in diffuse, soft light.

The radius of curvature of the secondary reflector 14 and the distance of the LED chip 30 from the secondary reflector 14 (marked as distance 54 in FIG. 5) will affect the properties of the light emitted by the soft light 10. Increasing the distance 54 will result in greater light spread before it reaches the secondary reflector 14, yielding more diffuse light of lower intensity. In a preferred embodiment, using a 26 mm, 150 W LED chip and the preferred primary reflector dimensions discussed above, the distance 54 from the LED chip 30 to the secondary reflector is between approximately 4.75 and 5.25 inches, and in a further preferred embodiment, is between approximately 4.95 and 5.00 inches. Changing the radius of curvature will also affect the softness and intensity of the light. In a preferred embodiment, in order to maximize light output, the radius of curvature is between approximately 12 and 18 inches, and, more preferably, is approximately 15 inches. The secondary reflector may have constant radius of curvature throughout, or it may have a varying radius, in which case, the radius of curvature may be measured or approximated at the point of intersection of the beam of light 60 and the secondary reflector 14. This preferred embodiment results in a soft light with a very high light output, wherein the light emitted from the four LED assemblies 30 is sufficiently blending to cast a diffuse, soft light. In a preferred embodiment, the desired light output is approximately 12,500 lumens for each LED assembly. Therefore, for the four-light configuration shown in FIG. 1, the desired light output is at least approximately 50,000 lumens, and for the two-light configuration shown in FIG. 1, the desired light output is at least approximately 25,000 lumens.

Similar to the primary reflectors 32, the material of the secondary reflector 14 may impact the intensity and softness of light reflected. For example, there are numerous shades of white that may be used to offer different softness or light level characteristics. Further, the texture of the white reflection surface of the secondary reflector 14 will affect the softness of the bounced light, and the reflectance of the white reflection surface will affect both softness and the amount of light reflected, i.e., light output level. The exact material selected will depend on the level of softness and light output desired for a particular application. In some applications, it may be desirable to use a material that will sufficiently diffuse the light to combine and soften the light output while still being highly reflective so as to maximize the diffused light output. An example of such a material is 24 gauge low gloss white aluminum, which has a reflective white surface that diffuses the emitted light while maintaining high light output.

It can be seen in the figures that the beam of light 60 reflected off of the secondary reflector 14 exits through an opening 15 in the front region of the soft light 10. As discussed above, the opening 15 may be an opening, or a transparent or semi-transparent material through which the light exits the soft light. In order to maximize the light output by the soft light 10 and minimize interference by the upper and lower bounds of the exit opening 15, it may generally be desirable for the beam of light 60 to be directed towards the center of the exit opening 15. In order to effectively direct the beam of light 60 towards the center of the exit opening 15, the LED assembly 16 is mounted to a rear panel 50 of the trough assembly 12 at a pre-determined angle. The angle from the rear panel 50 to the LED chip 30 is marked as angle 52. This angle 52 determines the angle at which the light emitted from the LED assembly 30 is directed towards the secondary reflector 14. The secondary reflector's radius of curvature and the angle 52 of the LED assembly 16 generally determine the direction of the beam of light 60 reflected off of the secondary reflector 14 and emitted by the soft light 10. In the preferred embodiment described above, the angle 52 of the LED chip to the rear panel 50 may be between approximately 60 and 80 degrees, with a preferred measurement of approximately 72 degrees. This embodiment results in the beam of light 60 reflecting off the secondary reflector 14 at an angle between approximately 25 and 45 degrees from the normal line at the point of reflection, or, more preferably, between approximately 35 and 40 degrees. The tangent and normal lines are depicted in FIG. 5, and the angle of light beam 60 is marked as angle 65. In the depicted embodiment, the LED assembly 30 is angled from the rear panel 50 (angle 52) at approximately 72 degrees, which results in the light beam 60 intersecting the secondary reflector 14 at an angle of approximately 37 degrees relative to the normal line at the point of intersection (angle 65). This particular angle of reflection results in the beam of light 60 exiting the soft light 10 at close to the center of the exit opening 15 so as to maximize light output.

By changing the secondary reflector 14's radius of curvature, the softness and intensity of the light may be slightly varied. In FIG. 5, it can be seen that the secondary reflector 14 has a vertical edge 56 at its top end which is in contact with a set of screws 44. In the embodiment shown in FIGS. 4 and 5, the radius of curvature of the secondary reflector 14 may be adjusted by moving screws 44 in or out. As the screws 44 are moved inward, the vertical edge 56 is pushed inward, decreasing the radius of curvature of the secondary reflector 14. As the screws 44 are moved outward, the vertical edge 56 also moves outward, and the radius of curvature is increased. In a preferred embodiment, the screw is approximately 0.5 inches in length, and adjusting the position of the screw may result in the radius of curvature being adjusted from a range of approximately 12.25 inches to 17.25 inches.

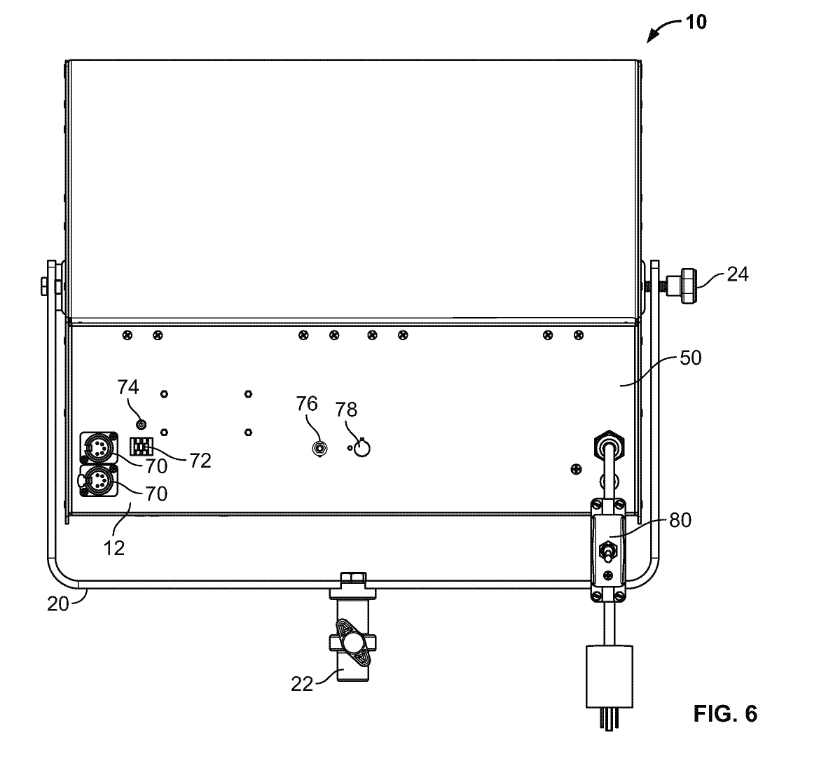

FIG. 6 provides a rear perspective view of the soft light 10. The rear panel 50 of the trough assembly 12 includes several connections and controls with which to control the soft light 10. In the depicted embodiment, the rear panel 50 includes two DMX control connections 70 which allow a DMX controller to be connected to the soft light 10 for remote control of the light. A counter 72 allows the user to set a control channel for the soft light 10 such that individual soft lights or groups of soft lights may be controlled by one or more DMX controllers based on the channel setting of each soft light. For example, if one soft light is set to channel 1, and three soft lights are set to channel 2, then the one channel 1 soft light can be controlled individually by a DMX controller set to control channel 1, and the three soft lights set to channel 2 may be controller by the same or a different DMX controller set to control channel 2 devices. A DMX status LED 74 indicates whether DMX control is activated.

A switch 76 switches the soft light 10 between manual mode, in which the soft light 10 is controlled manually, and DMX mode, in which the soft light is controlled via DMX controller. A control knob 78 allows for manual dimming of the soft light 10 when the switch 76 is set to manual control. A power switch 80 controls power to the soft light 10.

Although the invention has been disclosed with reference only to presently preferred embodiments, those of ordinary skill in the art will appreciate that various modifications can be made without departing from the invention. The specification and figures are, accordingly, to be regarded in an illustrative rather than a restrictive sense. As such, the present invention is defined only by the following claims and recited limitations.

1. A soft light comprising:
a trough assembly;
a plurality of LED light assemblies housed within the trough assembly, each of the LED light assemblies comprising
an LED chip having one or more LEDs to emit light and
a primary reflector surrounding the one or more LEDs to direct the light emitted by the one or more LEDs, each primary reflector having a reflector angle and a reflector height; and
a secondary reflector having a radius of curvature and a curved, white reflection surface, the secondary reflector positioned proximate a rear portion of the trough assembly to reflect the light emitted by the plurality of LED light assemblies, wherein
the primary reflectors direct the light emitted by the one or more LEDs towards the secondary reflector, and
the light directed towards the secondary reflector by each of the primary reflectors is reflected by the white reflection surface of the secondary reflector and directed out of a front region of the soft light.

2. The soft light of claim 1, wherein the reflector angle of each primary reflector is between approximately 45 and 65 degrees, inclusive.

3. The soft light of claim 2, wherein the reflector angle of each primary reflector is approximately 55 degrees.

4. The soft light of claim 1, wherein the reflector height of each primary reflector is between approximately 1 and 3 inches, inclusive.

5. The soft light of claim 4, wherein the reflector height of each primary reflector is approximately 2 inches.

6. The soft light of claim 1, wherein each primary reflector comprises mirror finish aluminum sheet material.

7. The soft light of claim 1, wherein the secondary reflector has a radius of curvature between approximately 12 inches and approximately 18 inches, inclusive.

8. The soft light of claim 1, wherein the soft light further comprises a curvature adjustment mechanism to adjust the radius of curvature of the secondary reflector.

9. The soft light of claim 8, wherein the curvature adjustment mechanism is able to adjust the radius of curvature of the secondary reflector from a range of approximately 12.25 inches to approximately 17.25 inches.

10. The soft light of claim 1, wherein the secondary reflector comprises low gloss white aluminum.

11. The soft light of claim 1, wherein each LED chip is a 150 W LED chip.

12. The soft light of claim 1, wherein the distance from each LED chip to the secondary reflector, measured perpendicular to the LED chip, is between approximately 4 and 6 inches, inclusive.

13. The soft light of claim 12, wherein the distance from each LED chip to the secondary reflector, measured from the center of the LED chip, perpendicular to the LED chip, is between approximately 4.95 and 5.00 inches, inclusive.

14. The soft light of claim 1, wherein the plurality of LED light assemblies are positioned such that the light emitted by the plurality of LED light assemblies is directed towards the secondary reflector at a predetermined angle, the predetermined angle being defined relative to the normal of the tangent line to the secondary reflector at the point of intersection of the emitted light and the secondary reflector.

15. The soft light of claim 14, wherein the predetermined angle is between approximately 30 and 45 degrees.

16. The soft light of claim 15, wherein the predetermined angle is approximately 37 degrees.

17. The soft light of claim 1, wherein the soft light generates a light output of at least approximately 12,500 lumens for each LED light assembly.

18. The soft light of claim 1, further comprising a DMX input for connecting a DMX controller to allow for remote control of the soft light.

19. A soft light comprising:
a trough assembly having a rear portion and a front portion;
a plurality of LED light assemblies housed within the trough assembly, each of the LED light assemblies comprising
an LED chip having one or more LEDs to emit light, and
a primary reflector surrounding the one or more LEDs to direct the light emitted by the one or more LEDs, each primary reflector having a reflector angle and a reflector height;
a secondary reflector having a radius of curvature and a curved, white reflection surface, the secondary reflector positioned proximate the rear portion of the trough assembly to reflect the light emitted by the plurality of LED light assemblies; and
a curvature adjustment mechanism to adjust the radius of curvature of the secondary reflector, wherein,
the primary reflectors direct the light emitted by the one or more LEDs towards the secondary reflector,
the light directed towards the secondary reflector by each of the primary reflectors is reflected by the white reflection surface of the secondary reflector and directed out of the front portion of the trough assembly,
the reflector angle of each primary reflector is between approximately 45 and 65 degrees, inclusive,
the reflector height of each primary reflector is between approximately 1 and 3 inches, inclusive,
the distance from each LED chip to the secondary reflector, measured perpendicular to the LED chip, is between approximately 4 inches and 6 inches, inclusive, and
the soft light generates a light output of at least approximately 12,500 lumens for each LED light assembly.

20. The soft light of claim 19, further comprising a DMX input for connecting a DMX controller to allow for remote control of the soft light.
